(19) United States
(12) Patent Application Publication
(10) Pub. No.: US 2018/0183636 A1
(43) Pub. Date: Jun. 28, 2018

(54) METHODS AND APPARATUS FOR EFFICIENT LOW-IF RECEIVERS

(71) Applicant: Texas Instruments Incorporated, Dallas, TX (US)

(72) Inventors: Raghu Ganesan, Bangalore (IN); Yogesh Darwhekar, Bangalore (IN); Subhashish Mukherjee, Bangalore (IN)

(21) Appl. No.: 15/391,675

(22) Filed: Dec. 27, 2016

(51) Int. Cl. H04L 27/06; H04L 12/26

(52) U.S. Cl. CPC H04L 27/06; H04L 43/16

(57) ABSTRACT

Described examples include a method for operating a receiver including receiving an output of an in-phase IF path; receiving an output of a quadrature IF path; measuring a blocker power on a plurality of IF channels on at least one of the in-phase path and the quadrature path within a fraction of a symbol interval; selecting a selected one of the plurality of IF channels having a low blocker power as an image channel; and providing a local oscillator output to the in-phase IF path and quadrature IF path operate corresponding to the image channel, such that a frequency of the local oscillator output is changed within a fraction of the symbol interval.

### TECHNICAL FIELD

This application relates generally to radio frequency reception, and, in particular, to low intermediate frequency (IF) configurations.

### BACKGROUND

Blocker tolerance is an important specification in wireless receivers. A blocker is anything that interferes with demodulating a received signal. Wireless standards typically specify receiver tolerance for specific levels and the frequencies of potential blockers. For example, Digital Microwave Radio (DMR, ETSI TS 102 658), Personal Microwave Radio (PMR, ETSI EN 303 039) & Tetra (ETSI EN 300 394-1) are standards defined by the European Telecommunications Standards Institute (ETSI), which are incorporated herein in their entirety by reference. These standards use very narrow channels (e.g., 6.5 kHz channel width) and operate in unlicensed spectrum. Therefore, receivers for these standards have stringent tolerances for rejecting blockers, such as Adjacent Channel Interferers (ACI). The ETSI DMR standard states that a receiver must be able to reject a signal on an adjacent channel that is up to 75 dB greater than the signal of interest (SOI). Such requirements present a difficult challenge to receiver designers.

Blocker specifications are critical for receiver architecture decisions. The blocker specifications determine the requirements including non-linearity, phase noise and image rejection in the receiver design. However, receiver components that are highly linear, have low noise and high performance are difficult to manufacture, consume more power and are expensive. In addition, as many receivers are increasingly made portable, minimizing power consumption is an additional challenge to preserve battery life.

### SUMMARY

In accordance with described examples, a method for operating a receiver includes receiving an output of an in-phase IF path; receiving an output of a quadrature IF path; measuring a blocker power on a plurality of IF channels on at least one of the in-phase path and the quadrature path within a fraction of a symbol interval; selecting a selected one of the plurality of IF channels having a low blocker power as an image channel; and providing a local oscillator output to the in-phase IF path and quadrature IF path operate corresponding to the image channel, such that a frequency of the local oscillator output is changed within a fraction of the symbol interval.

### BRIEF DESCRIPTION OF THE DRAWINGS

FIG. 1 is a diagram of a Low-IF receiver.

FIG. 2 is a frequency graph that illustrates the blocker rejection requirements of an example standard.

FIG. 3 is a frequency graph that illustrates one of the problems caused by adjacent channel blockers.

FIG. 4 is a diagram of a Low-IF receiver according to an aspect of this application.

FIG. 5 is a schematic diagram of an example measurement portion of a channel monitor.

FIG. 6 is a superimposed amplitude plot for several signals received by a receiver.

FIG. 7 is a graph of a simulation showing the effect of shifting the channel.

FIG. 8 is a diagram of a receiver including decoding circuitry.

FIG. 9 is a graph of a simulation showing the output of an RRC filter.

FIG. 10 is a flow chart of an aspect method.

### DETAILED DESCRIPTION

Corresponding numerals and symbols in the different figures generally refer to corresponding parts unless otherwise indicated. The figures are not necessarily drawn to scale.

The term “coupled” may include connections made with intervening elements, and additional elements and various connections may exist between any elements that are “coupled.”

A receiver may begin demodulating an RF signal by mixing the RF signal with a locally generated sinewave signal. A local oscillator (LO) generates this signal. The frequency of the mixed signal is the frequency of the RF signal (f_{RF}) plus and minus the LO frequency (f_{LO}). A low pass filter eliminates the summed frequency, so the resulting signal is at f_{IF}=f_{RF}−f_{LO}.

The intermediate frequency or IF is a receiver design choice. In a super heterodyne receiver, the IF frequency is typically tens to hundreds of megahertz. A second mixing stage brings the IF signal to a base band (BB) level. Super heterodyne systems provide excellent signal discrimination. Receivers with excellent signal discrimination reject ACI and other blockers. However, the use of two mixing stages requires many analog components and is not power efficient.

In a Zero-IF receiver, the IF frequency is zero. That is, f_{RF} equals f_{LO} and the receiver lowers the received signal to the BB in one mixing stage. When compared to the super heterodyne receiver, this configuration lowers the number of analog components. However a Zero-IF receiver requires very precise components to provide good performance. That is, the components must provide high linearity, low distortion and low noise to avoid noise and DC offset issues. Zero-IF is not a good choice for systems like DMR, PMR and Tetra because the tight blocker requirements for these systems only increase the precision level required of the components used.

A low-IF receiver has the benefit of a low analog part count while avoiding most of the problems of a Zero-IF system. A Low-IF frequency is low enough to allow conversion of the IF signal into digital form for further processing, thus minimizing the number of analog components (relative to super heterodyne systems.)

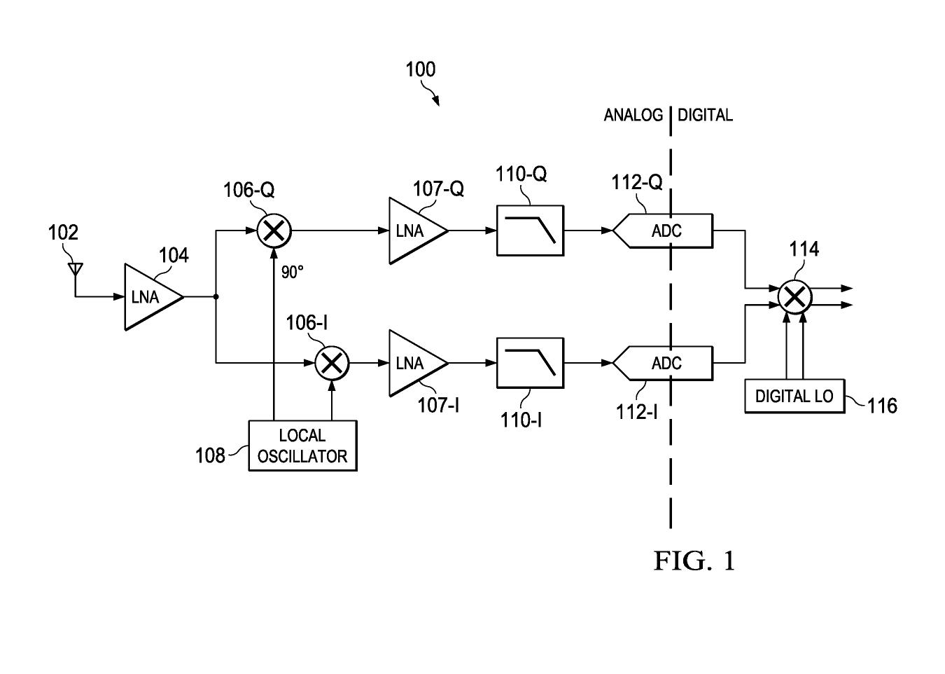

FIG. 1 is a diagram of a Low-IF receiver 100. Antenna 102 receives the RF signal, which low noise amplifier (LNA) 104 amplifies. Local oscillator 108 provides an in-phase signal to mixer 106-I and a quadrature phase (90° shifted) signal to mixer 106-Q. Mixers 106-I and 106-Q produce a signal having a frequency of f_{IF}=f_{RF}−f_{LO}. In Low-IF receivers, f_{LO} is close to f_{RF} so that f_{IF} is only a few bandwidths above zero. For example, if f_{RF} is 5 GHz and the bandwidth for this type of transmission is 25 kHz, f_{LO} may be set at 4.9999 GHz to provide an f_{IF} of 100 KHz. This relatively low frequency (hence the term “Low-IF”) allows for digital processing of the signal. Variable gain amplifiers 107-I and 107-Q amplify and couple the output of mixers 106-I and 106-Q, respectively, to low pass filters 110-I and 110-Q, respectively. A/D converters 112-I and 112-Q convert the in-phase and quadrature signals from low pass filters 110-I and 110-Q, respectively, into digital form. After A/D converters 112-I and 112-Q, the elements of 112-Q, 112-I, 114 and 116 in FIG. 1 represent digital implementations operating on an integrated circuit such as a digital signal processor (DSP), a field programmable gate array (FPGA), a mixed signal processor (MSP) or another suitable platform. In another aspect, A/D converters 112-Q and 112-I and/or low pass filters 110-I and 110-Q may also be integrated with the integrated circuit or included in a hybrid module. Mixer 114 converts the in-phase and quadrature IF signals to base band signals by mixing the output A/D converters 112-I and 112-Q with the output of digital local oscillator 116, which provides a signal having a frequency equal to f_{IF}. Further digital processes (not shown) process the output of mixer 114 to extract the signal of interest (SOI).

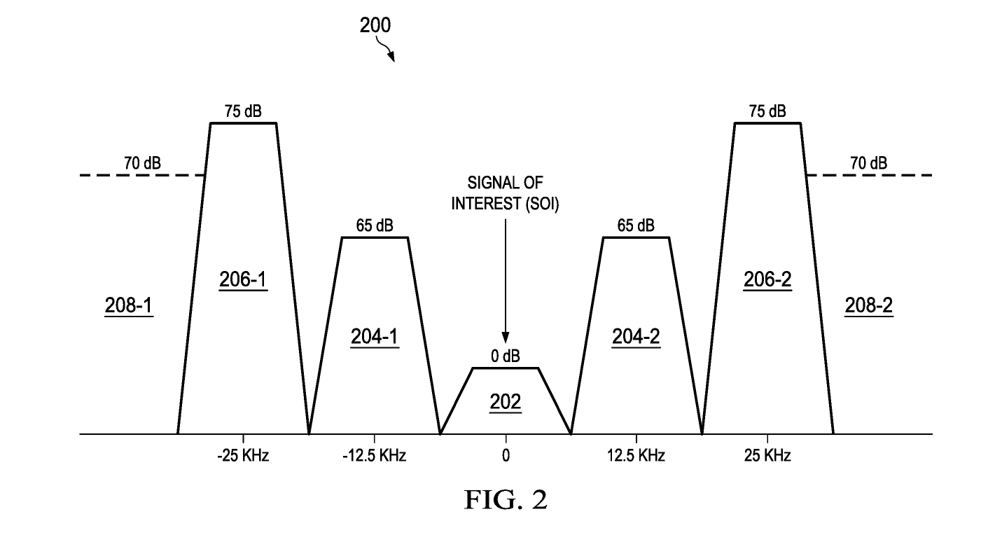

FIG. 2 illustrates in a frequency graph the blocker rejection requirements of an example standard. These example adjacent channel interferer (ACI) requirements are taken from the ETSI DMR standard. The channels have a bandwidth of 12.5 kHz and there are no guard bands between channels. In FIG. 2, channels 204-1 and 204-2 are directly adjacent to SOI 202. A receiver meeting the DMR standard must be capable of recovering the SOI 202 when one or both of channels 204-1 and 204-2 have a signal that is 65 dB greater than SOI 202. In addition, the receiver must reject the next adjacent signals 206-1 and 206-2 if they are 75 dB greater than SOI 202. Finally, the receiver must reject any other interference 208-1 and 208-2 if it is 70 dB greater than SOI 202.

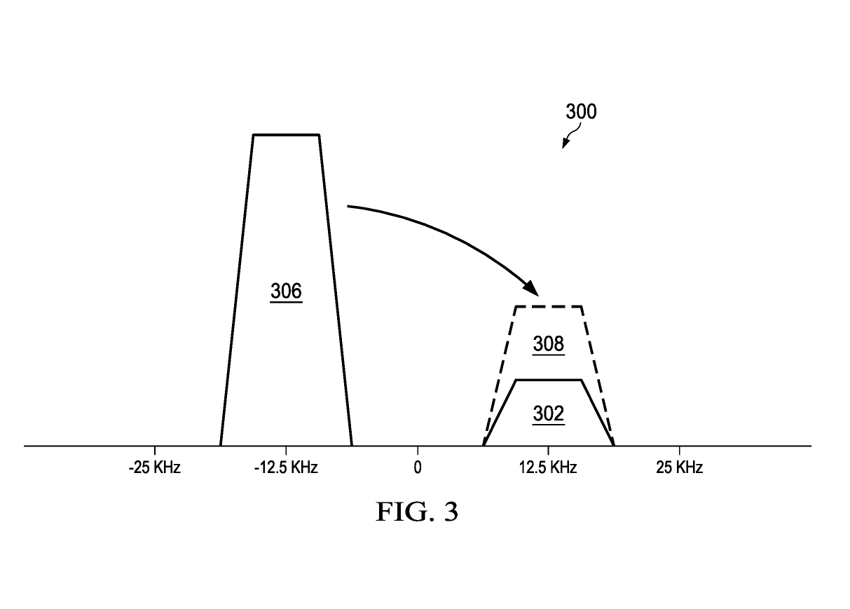

FIG. 3 illustrates in another frequency graph one of the problems caused by adjacent channel blockers. In graph 300, the f_{IF} is 12.5 kHz. Therefore, the SOI 302 centers at 12.5 kHz. However, the second closest ACI 306 centers 25 kHz away from SOI 302. This places ACI 306 at −12.5 kHz after the RF level ACI 306 mixes with the local oscillator signal. However, −12.5 kHz is 12.5 kHz 180° out of phase. Thus, a shadow ACI 308 will form in the band of the SOI 302.

These factors place extreme requirements on the quality of components, such as LNA 104, local oscillator 108, mixers 106-I and 106-Q, variable gain amplifiers 107-I and 107-Q, low pass filters 110-I and 110-Q, and A/D converters 112-I and 112-Q (FIG. 1). The strict requirements are due to non-linearity and noise in the components that add distortions that must be overcome. Specifically, second intercept point (IP2) and third intercept point (IP3) non-linearity must be very high, because the higher the IP3 and IP2 are, the lower the distortion will be. Also, the image rate rejection (IMRR) of the mathematical processing must be very high. Components that have these characteristics are expensive to produce and often consume more power than less accurate components. In addition, system and circuit designs for handling these problems are complex. All of this raises the cost and lowers the power performance of the receiver.

Zero-IF or direct conversion receivers avoid the problems due to blockers in the image band but have several other limitations. In Zero-IF the RF frequency f_{RF} is equal to local oscillator frequency f_{LO}. Therefore, the first mixing stage brings the signal to the base band. However, a Zero-IF receiver needs components with a high IP2 to tolerate ACI of the order of ˜75 dB. To meet the ETSI DMR standard, the IP2 of ˜60 dB for the overall receiver chain is necessary, which implies an IP2 of ˜80 dB for components such as the mixer. The ETSI DMR standard has tight specifications that are difficult to achieve, even with calibration to reduce mismatches. Another issue with the Zero-IF architecture is flicker noise. The ETSI DMR and Tetra systems have low bandwidth (one side of the bandwidth is ˜6 kHz). This implies a need for tighter specifications on the flicker corner.

A Low-IF architecture avoids the flicker noise issue and has low IP2 requirements, but has several other limitations. A high IP3 is needed when ACI falls in the image band, as in FIG. 3. The DMR standard specifies ACM & ACI-II and blockers at 1 MHz, but the receiver also needs to tolerate unwanted out-of-band signal of ˜70 dB anywhere between 25 kHz to 1 MHz. In addition, Low-IF receivers require high IMRR due to gain and phase imbalances in the I/Q paths so that the ACI in image band does not affect the sensitivity performance. The IMRR requirement implies a high IMRR of ˜95-100 dB, which requires precise estimation and correction in the digital receiver.

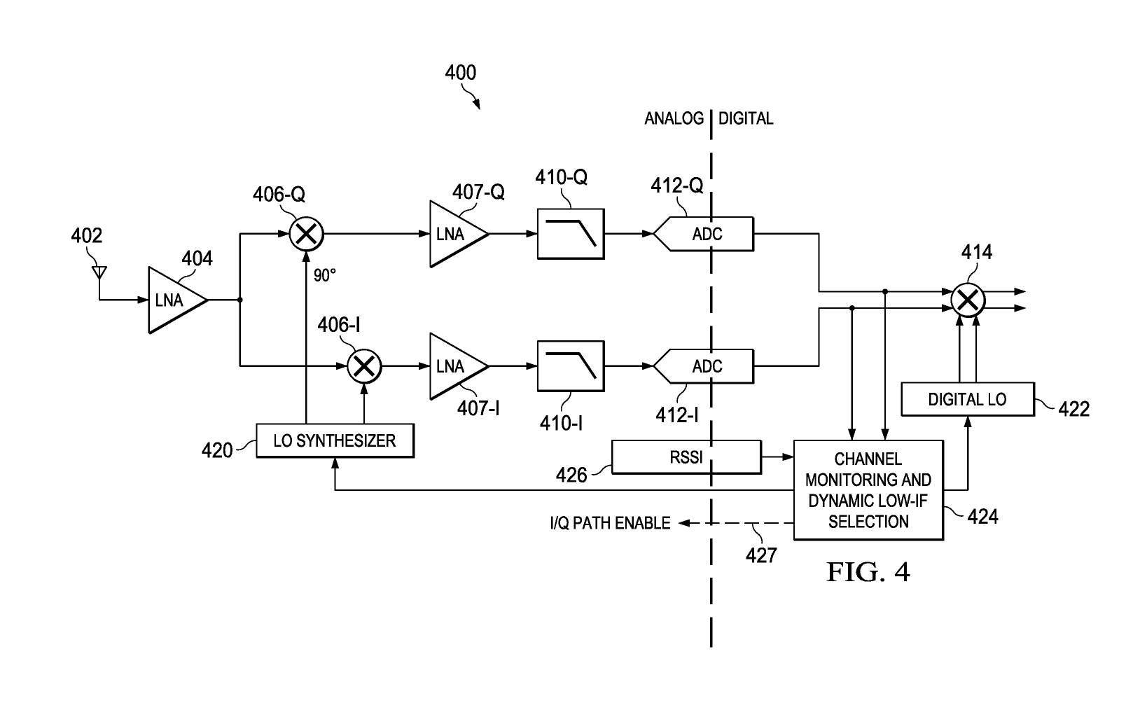

FIG. 4 is a diagram of a Low-IF receiver according to an aspect of this application. Similarly labeled components to those of FIG. 1 perform similar functions in receiver 400, for clarity. For example, antenna 402, LNA 404, mixers 406-I and 406-Q, variable gain amplifiers 407-I and 407-Q, low pass filters 410-I and 410-Q, A/D converters 412-I and 412-Q and digital mixer 414 perform similar functions to antenna 102, LNA 104, mixers 106-I and 106-Q, variable gain amplifiers 107-I and 107-Q, low pass filters 110-I and 110-Q, A/D converters 112-I and 112-Q and digital mixer 114, respectively. The in-phase path of receiver 400 includes antenna 402, LNA 404, mixer 406-I, variable gain amplifier 407-I, low pass filter 410-I and A/D converter 412-I. The quadrature path of receiver 400 includes antenna 402, LNA 404, mixer 406-Q, variable gain amplifier 407-Q, low pass filter 410-Q and A/D converter 412-Q. Receiver 400 also includes local oscillator (LO) synthesizer 420 and variable digital local oscillator (LO) 422. Channel monitor 424 controls LO synthesizer 420 and variable digital local oscillator 422. Channel monitor 424 receives an overall strength signal from received signal strength indicator (RSSI) 426. In addition, channel monitor 424 receives the output of both A/D 412-I and A/D 412-Q. After the A/D converters 412-I and 412-Q, the elements of 414, 422, 424 and 426 in FIG. 4 represent digital implementations operating on an integrated circuit such as a digital signal processor (DSP), a field programmable gate array (FPGA), a mixed signal processor (MSP), a reduced instruction set computer (RISC) core, an ARM core, or another suitable platform. In another aspect, A/D converters 412-Q and 412-I and/or low pass filters 410-I and 410-Q may also be integrated with the integrated circuit or may be included in a hybrid module.

LO synthesizer 420 provides a local oscillator output of one of several local oscillator signals corresponding to one of several possible IF frequencies f_{IF} (channels). Each of these possible IF frequencies are above zero frequency. The larger the number of possible IF frequencies, the greater the probability that at least one IF frequency has a low blocker energy. In an aspect, the number of possible IF frequencies is large enough so that the probability that at least one IF image frequency has low blocker energy is high (e.g. >95%). Therefore, to allow room for adjusting the IF frequency, the central IF frequency that LO synthesizer may provide is higher than a normal Low-IF configuration. For example, if the bandwidth of the transmitted channels is 10 kHz, LO Synthesizer 420 may provide LO signals such that f_{IF} is one of 5, 15, 25, 35, 45, 55, 65, 75, 85, 95, 105, 115 or 125 kHz, with 65 kHz as the central frequency (this bandwidth and the possible f_{IF} frequencies are selected for ease of explanation. These frequencies do not necessarily correspond to any transmission standard and do not limit the scope of this aspect). Channel monitor 424 selects one of these f_{IF} frequencies, as further explained hereinbelow. Channel monitor 424 also selects an operating frequency for digital LO 422 corresponding to the LO frequency selected for LO synthesizer 420. For example, if the RF frequency of concern is at 5.000065 GHz, the LO frequency output by LO synthesizer 420 can be 5 GHz, yielding an f_{IF} of 65 kHz. Digital LO is then set to 65 kHz so that the output of digital mixer 414 is at the base band.

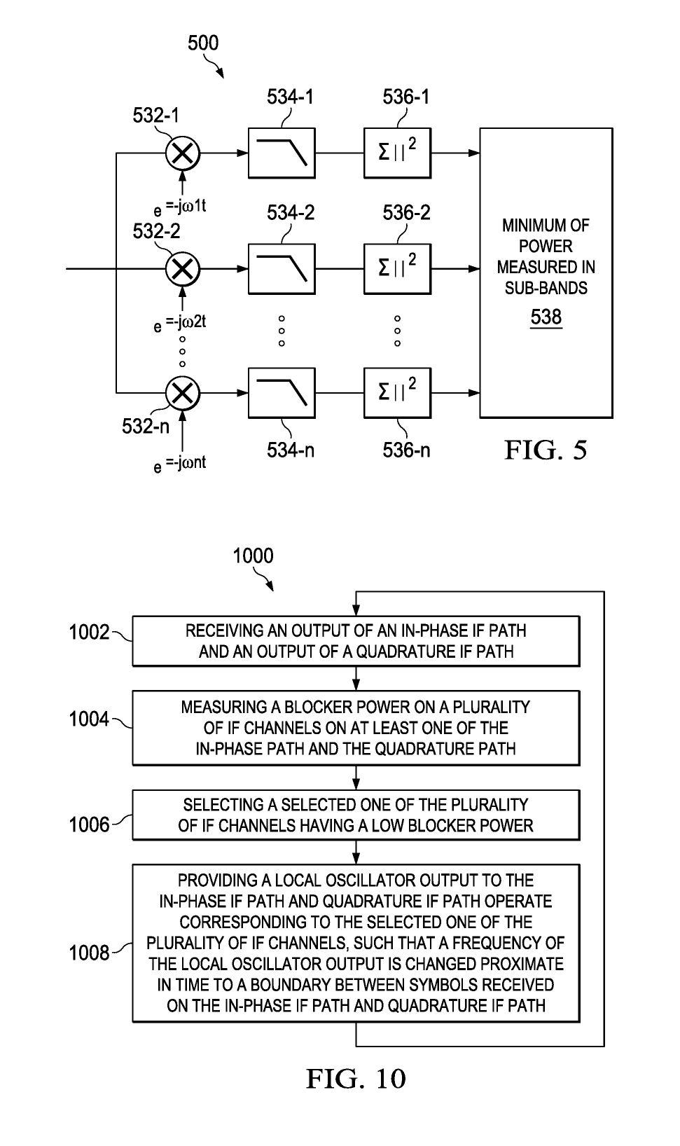

FIG. 5 is a circuit diagram of an example measurement portion of channel monitor 424 (FIG. 4). Channel measurement section 500 measures each channel to determine the power of interferers on each of the available channels. The outputs of A/D converters 412-I and 412-Q (FIG. 4) couple to one input of mixers 532-1 to 532-n. The other mixer input for each channel has a frequency equal to the center of the measured IF channel relative to the baseband. Each mixer outputs a baseband level signal corresponding to its monitored channel to low pass filters 534-1 to 534-n. The output of low pass filters 534-1 to 534-n is the energy on the respective channel (with the currently used channel being corrected for the SOI), which couples to accumulators 536-1 to 536-n, respectively. Accumulators 536-1 to 536-n sum the square of the absolute value of outputs of low pass filters 534-1 to 534-n to provide a measure of the energy on the respective channel to power monitor 538. In this aspect, the components of FIG. 5 are in the digital domain. Therefore, software can execute each of these functions on, for example, a DSP. The components of FIG. 5 may be implemented as stand-alone components, but are more conveniently executed in a processor in the digital domain. In another aspect, a processor may perform the functions of channel measurement section 500 by executing fast Fourier transforms (FFT) centered at each channel to provide the energy level within each channel.

Lower data rate standards, such as ETSI DMR, can be exploited by designing channel energy measurement blocks that can provide measurements within a fraction of a symbol period. Using such designs, channel measurement section 500 can measure the channel energy while a symbol is being received. With DMR-like applications, the blockers are close-by, which increases the system cost because of their arrangement of close proximity with the signal of interest. The blockers are close to the SOI because the channel band-width or data rate is low. However, aspects described herein exploit the low data rate and high blocker power levels to do channel measurement within a fraction of symbol period. In another aspect, Channel monitor 424 (FIG. 4) selects a channel such that it has the lowest blocker power in the image band for use in receiving the next symbol or for subsequent symbols. The actual switch from one f_{IF} to another occurs within a fraction of symbol period. In the case of an application using digital modulation waveforms, the switch occurs away from the eye-opening point i.e., in the interstices between symbols to avoid symbol errors.

For example, in a system using ETSI DMR, the bit-rate is 4.8 Kbps and the symbol rate is 2.4 KSps for a symbol period of >400 μs. The blocker power measurement interval of channel measurement section 500 is a small fraction of the symbol period, particularly if the blocker signals are 10 s of dB greater than the SOI. Using the aspect where channel measurement section 500 uses an FFT for each channel as an example, a 32 point FFT operating at a sampling rate of 640 kHz can measure the power of 32 20 kHz sub-bands in 50 μs. The local oscillator locking time is ˜40-50 μs when using a technique like that shown in U.S. Patent Application Publication No. 2015/0381190 A1, which is co-owned by the owner of this application and which is hereby incorporated by reference herein in its entirety. Therefore, channel monitor 424 can find the channel with the lowest blocker noise and switch the LO synthesizer 420 to use the f_{IF} of that channel well with in a small fraction of one symbol period. In addition, faster channel measurement and channel switching would allow for application of these aspects to transmission standards with higher symbol rates.

In another aspect, the energy of each of the channels are measured for an interval of time comparable to that of symbol period, but many such measurements can be done in a staggered manner to get channel power update every small fraction of the symbol interval. In this case, the higher measurement interval adds to the reliability of the measurement, yet because of the faster update rate of the measurement, the receiver is able to respond quickly to the appearance or disappearance of blockers.

Using information from the channel monitor regarding the blocker frequency and power, the described receivers can also calculate the frequency of the new Intermodulation (IMD) product due to a different selection of Low-IF frequency. This also is used to select the optimal Low-IF. For example, in case of 3^{rd} order non-linearity (IP3), one of the IMD product frequencies is given by 2f1+f2, where f1 and f2 are the frequency of the blocker 1 and 2, respectively. With a change in Low-IF frequency by ±δ, the IMD frequency is changed to 2(f1±δ)+(f2±δ). In the case of this IMD being closer to image channel for the signal-of-interest and its level being appreciable, as predicted by the receiver, such a selection of Low-IF frequency is avoided.

In systems that use digital modulation, the channel monitor and the LO switching may be synchronized with the eye-opening point (or the optimum sampling point). FIG. 6 is a superimposed time and amplitude plot 600 of several signals received by a receiver like receiver 400 (FIG. 4). Eye opening point 640 is the beginning of a symbol period 644. Channel monitor 424 can monitor the channel blocker noise during the first portion of the symbol period 644. During the first portion of the symbol period 644, channel monitor 424 determines and selects the channel with the better blocker noise characteristics. After receiver 400 receives the symbol transmitted in symbol period 644 and at a time close to boundary 642, channel monitor 424 switches the LO synthesizer to the new channel and provides the new information to digital LO 414. This helps in reducing the bit error rate due to LO switching as the LO switching is done away from the eye-opening point. Alternatively, the LO can be switched in synchronization with the symbol timing recovery, where the LO is switched after the sampling of the eye-opening point by the decision making module, thereby there is more time for LO switching effects to settle before the next eye-opening point of the subsequent symbol. This allows receiver 400 to continuously select the channel with better blocker noise characteristics, such as the channel with the lowest blocker noise.

In another aspect, if the image blocker noise is low enough on the selected channel, there is no need for both an in-phase (I) and quadrature phase (Q). These two phases are used in downstream decoding to more accurately decode the correct symbol in the presence of blockers in the image channel. However, by continuously selecting the image channel to be the channel having the lowest blocker noise, channel monitor 424 can shut down one of the I or Q paths using I/Q path enable 427 when the blocker noise is below a selected threshold because both paths are not needed. By selectively disabling one of the paths, the system can save the power that would otherwise be necessary to drive the disabled path.

In the case of using only the I-path (or the Q-path), the digital part of the Q-path (or I-path) is disabled. The digital mixer then down-converts the real signal to the complex base-band by de-rotating with digital Low-IF signal. The digital mixer, in this case, also scales the signal by √2 to compensate for the 3-dB loss due to using only the I-path (or the Q-path).

In the case of using only the I-path (or the Q-path) due to negligible image band blocker power, the channel is continuously observed for any change in the in-band power. In the case of in-band power greater than a given threshold, possibly due to the sudden appearance of an image blocker, the decision to enable the other quadrature path is taken and the digital mixer is also appropriately set.

Also, because the lowest noise channel is continuously selected as the image band for the signal-of-interest, design requirements for the analog components in receiver 400 can be relaxed. To meet standards requirements, the worst blocking circumstances are assumed and the receiver design is arranged to handle that circumstance. For example, using other techniques, the components must be able to reject blocker noise such as that illustrated in FIG. 3. However, in the described aspects of this application, the receiver 400 (FIG. 4) continuously moves the channel away from difficult blocker noise like shadow ACI 308 (FIG. 3). By providing the largest margin possible between blocker noise and signal, second intersect point (IP2), third intersect point (IP3) and other linearity and noise rejection quality factors can be relaxed. This allows for a less expensive and more power efficient operation for receiver 400. In addition, when a very quiet channel is available, receiver 400 may be able to shift some components such as LNA 404, mixers 406-I and 406-Q, variable gain amplifiers 407-I and 407-Q, low pass filters 410-I and 410-Q and A/D converters 412-I and 412-Q to lower power modes, thus saving more power. For example, the gain of the RF-Analog blocks are reduced to reduce power consumption. Also, the biasing points of the RF-Analog blocks are changed to reduce power consumption. Moreover, the order of filtering in the receiver is changed to lower order and a section of the filter by-passed and disable to reduce power consumption.

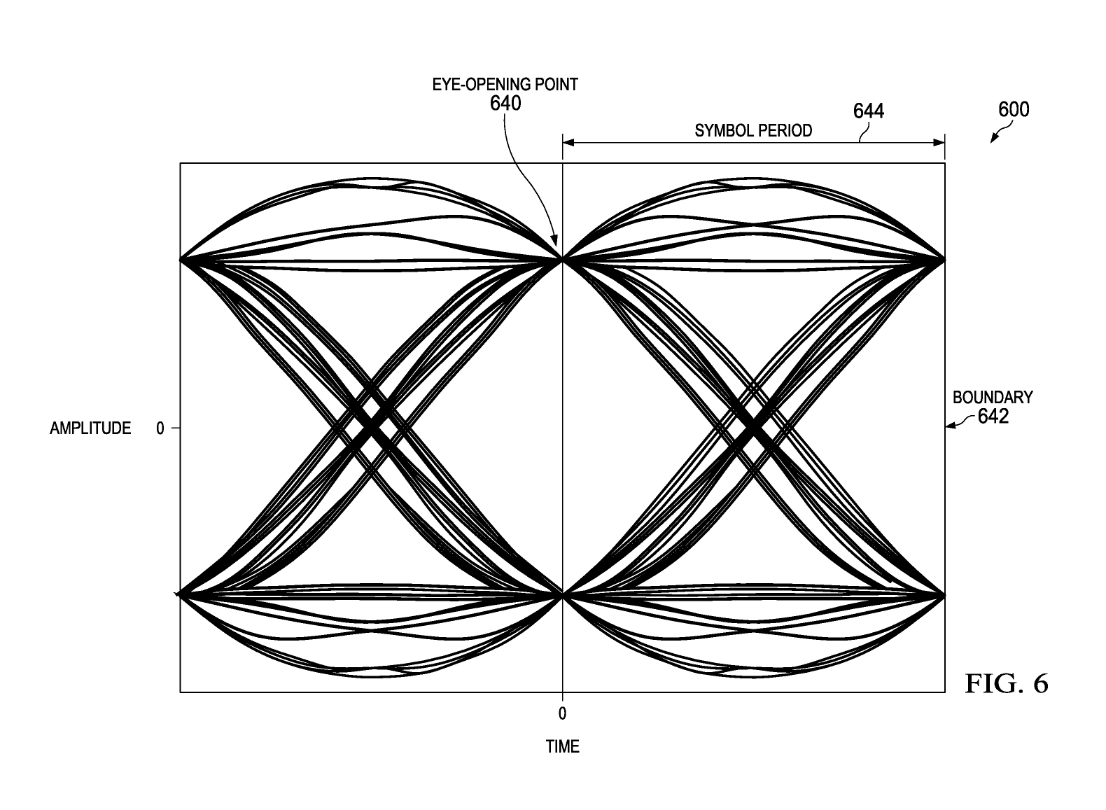

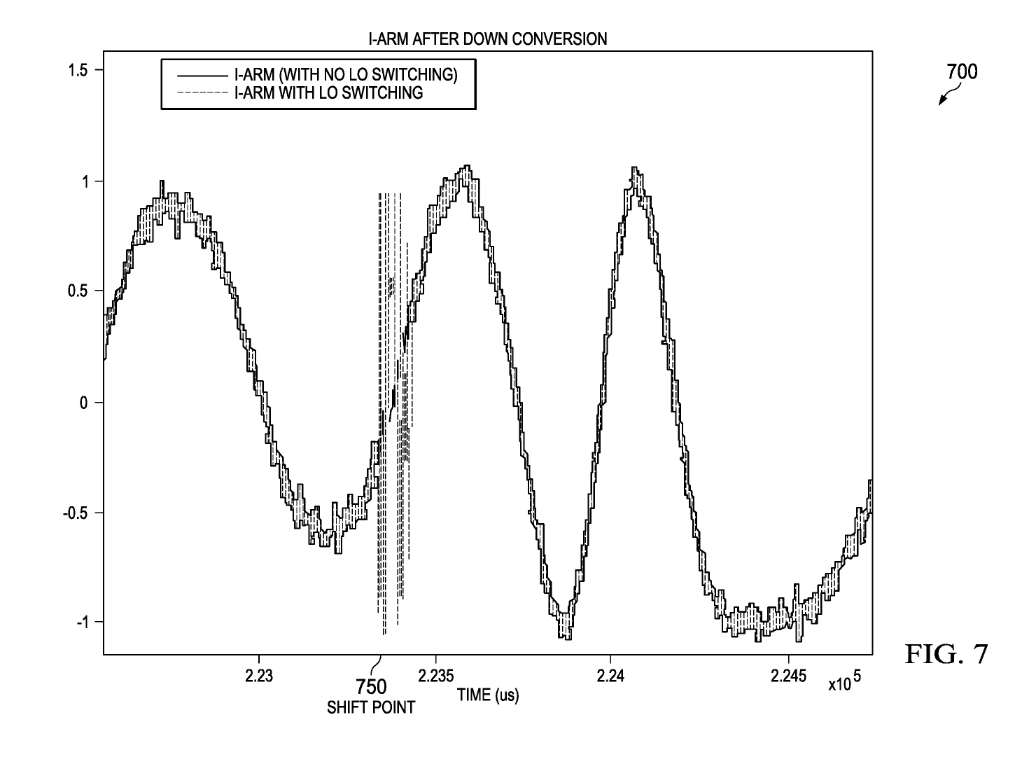

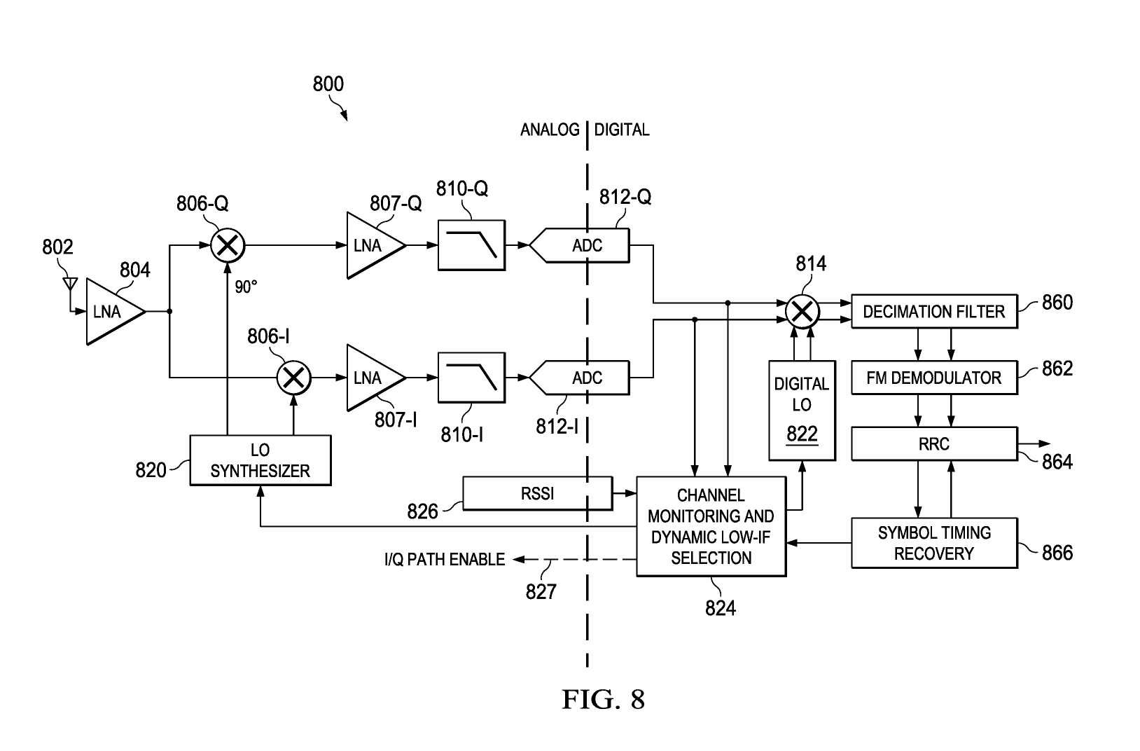

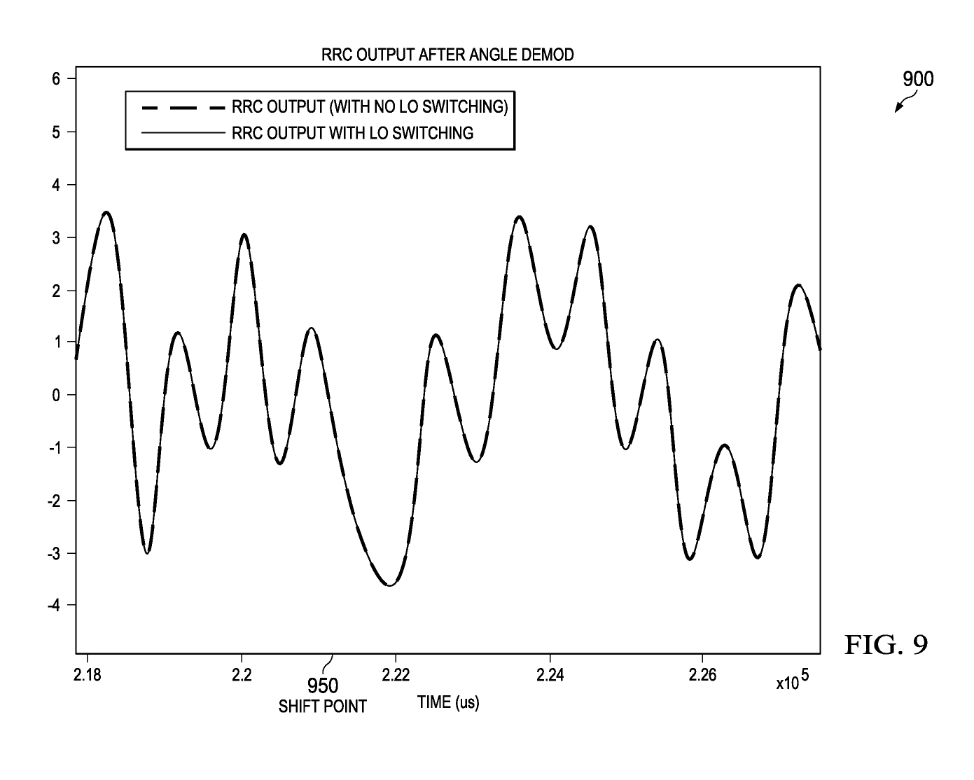

FIG. 7 is a graph of a simulation showing the effect of shifting the channel in receiver 400. Graph 700 shows the output of the in-phase arm of receiver 400, which is the digital output of A/D converter 412-I. A similar effect occurs with the quadrature arm, but is not show here for simplicity. Graph 700 shows the output with and without a change in the LO frequency. The change in frequency occurs at shift point 750. Graph 700 shows significant disruption of the in-phase output at the shift point. However, because the change in LO frequency occurs at the boundary 642 (see FIG. 6), this disruption does not affect receiving the symbol as further described regarding FIGS. 8 and 9 hereinbelow.

FIG. 8 is a diagram of another example aspect for a receiver 800 that is similar to receiver 400, but that includes some of the decoding circuitry. Similarly labeled components to those of FIG. 4 perform similar functions in receiver 800. For example, antenna 802, LNA 804, mixers 806-I and 806-Q, variable gain amplifiers 807-I and 807-Q, low pass filters 810-I and 810-Q, A/D converters 812-I and 812-Q, digital mixer 814, channel monitor 824, RSSI unit 826, I/Q path enable 827, LO synthesizer 820 and digital LO 822 perform similar functions to antenna 402, LNA 404, mixers 406-I and 406-Q, variable gain amplifiers 407-I and 407-Q, low pass filters 410-I and 410-Q, A/D converters 412-I and 412-Q, digital mixer 414, channel monitor 424, RSSI unit 426, I/Q path enable 427, LO synthesizer 420 and digital LO 422, respectively. The baseband output of digital mixer 814 couples to decimation filter 860. Loosely speaking, “decimation” is the process of reducing the sampling rate. In practice, this usually implies low pass-filtering a signal, then throwing away some of its samples. “Down-sampling” is a more specific term which refers to just the process of throwing away samples, without the low pass filtering operation. This process provides a cleaner sampling that lowers the computational complexity of further processing. The decimated signal couples to FM demodulator 862. The output of demodulator 862 couples to root raised cosine (RRC) filter 864, which minimizes inter-symbol interference. The output of RRC 864 couples to further decoding circuitry (not shown) to recover the symbols. FIG. 8 is configured to demodulate certain types of signals. Other demodulation configurations are also within the scope of the described aspects. The RRC filter 864 also couples to symbol timing recovery circuit 866 that allows the channel monitor 824 to operate synchronously with symbol timing recovery. After A/D converters 812-I and 812-Q, the elements of 814, 822, 824, 826, 860, 862 and 864 in FIG. 8 represent digital implementations operating on an integrated circuit such as a digital signal processor (DSP), a field programmable gate array (FPGA), a complex programmable logic device (CPLD), an application specific integrated circuit (ASIC), a mixed signal processor (MSP) or another suitable platform. In another aspect, A/D converters 812-Q and 812-I and/or low pass filters 810-I and 810-Q may also be integrated with the integrated circuit or included in a hybrid module.

FIG. 9 is a graph of a simulation showing the output of RRC filter 864 (FIG. 8). Graph 900 shows two graphs: one with LO switching and one with no LO switching. These graphs are identical, showing that LO switching does not affect the output of RRC filter 864, and thus does not affect symbol recovery. In particular, shift point 950 corresponds to shift point 750 (FIG. 7), which is where the channel switching occurs. The example in FIG. 9 shows that the channel switching does not degrade symbol recovery.

Thus, the aspects described hereinabove provide adaptive receivers that optimize the system performance in the presence of high interference blockers. The aspects address the problem of bit error during the dynamic selection of Low-IF frequency due to switching of blocks. The receivers incorporating the aspects are capable of detecting image band blockers within a fraction of symbol interval and also switching the Local Oscillator (LO) within a fraction of symbol period. Moreover, the aspect receivers optimize the power consumption of the receiver based on the blocker power measured.

FIG. 10 is a flow chart describing an aspect method. Method 1000 begins at step 1002 by receiving an output of an in-phase IF path and receiving an output of a quadrature IF path. At step 1004, the system measures a blocker power on a plurality of IF channels on at least one of the in-phase path and the quadrature path. At step 1006, the method selects a one of the plurality of IF channels having a low blocker power. At step 1008, the method provides a local oscillator output to the in-phase IF path and quadrature IF path operate corresponding to the selected one of the plurality of IF channels. The selection is made such that a frequency of the local oscillator output is changed proximate in time to a boundary between symbols received on the in-phase IF path and quadrature IF path. Following step 1008, method 1000 then returns to step 1002.

In an example aspect, an integrated circuit includes a first input coupled to receive an output of an in-phase IF path, a second input coupled to receive an output of a quadrature IF path, and a channel monitor coupled to the first and second inputs, the channel monitor configured to measure a blocker power on a plurality of IF channels within a fraction of a symbol interval and providing a local oscillator output coupled to a local oscillator that controls an IF channel used by the in-phase IF path and the quadrature IF path. Where the channel monitor is configured to select a selected one of the plurality of IF channels having a low blocker power as an image channel and provide a signal on the local oscillator output, causing the local oscillator to provide a local oscillator frequency such that the in-phase IF path and quadrature IF path operate at the image channel, such that the local oscillator frequency is changed within a fraction of the symbol interval.

In another example aspect, the signal on the local oscillator output is proximate in time to a boundary between symbols received on the in-phase IF path and quadrature IF path.

In another example aspect, each of the plurality of IF channels is measured during the symbol interval in a staggered manner.

In another example aspect, the in-phase path and the quadrature path further include: at least one of an IF amplifier, an IF filter, and an analog-to-digital converter, and each of the IF amplifiers, the IF filters, and the analog-to-digital converter is operated with a bandwidth substantially higher than an actual channel bandwidth. In a further example aspect, the plurality of IF channels is a number of IF channels such that a probability that of at least one of the plurality of IF channels has a low blocker energy is high.

In another example aspect, the channel monitor is configured to select the channel having a lowest blocker power for the image channel.

In yet another example aspect, the channel monitor determines an IMD product of the plurality of IF channels to determine an effect of blockers on the IMD product to select an IF channel where the blockers have low effect on the IMD product.

In another example aspect, the integrated circuit further includes a mixer to mix an output of at least one of the in-phase IF path and the quadrature IF path with a frequency corresponding to the image channel.

In another example aspect, at least a component of at least one of the in-phase path and the quadrature phase path operates in a lower power mode the blocker power of the image channel is below a threshold.

In a further example aspect, at least one of a gain and a biasing of at least a component of at least one of the in-phase path and the quadrature phase path operates and an order of filtering is selected based a blocker power of the image channel.

In another example aspect, the integrated circuit further includes a path enable signal to disable one of the in-phase IF path and the quadrature IF path when the blocker power of the image channel is below a threshold.

In another example aspect, a receiver includes an in-phase IF path providing a first output and a quadrature IF path providing a second output. The receiver also includes a local oscillator having an output coupled to the in-phase IF path and the quadrature IF path that controls an IF channel used by the in-phase IF path and the quadrature IF path, and having a frequency control input. The receiver also includes a channel monitor coupled to receive the first and second output, the channel monitor configured to measure a blocker power on a plurality of IF channels within a fraction of a symbol interval and provide a local oscillator frequency output coupled to the frequency control input of the local oscillator, the channel monitor configured to select a selected one of the plurality of IF channels having a low blocker power as an image channel and providing a signal on the local oscillator frequency output causing the local oscillator to provide a local oscillator frequency such that the in-phase IF path and quadrature IF path operate at the image channel, such that the local oscillator frequency is changed within a fraction of the symbol interval.

In another example aspect, the in-phase path and the quadrature path further include: at least one of an IF amplifier, an IF filter, and an analog-to-digital converter, and the IF amplifiers, the IF filters, and the analog-to-digital converter are operated with a bandwidth substantially higher than an actual channel bandwidth.

In another example aspect, the plurality of IF channels is a number of IF channels such that a probability that of at least one of the plurality of IF channels has a low blocker energy is high.

In yet another example aspect, the in-phase IF path and the quadrature IF path are configured to enter a lower power mode when the blocker power of the image channel is below a threshold.

In yet another example aspect, each of the plurality of IF channels is measured during the symbol interval in a staggered manner.

In a further example aspect, at least one of a gain and a biasing of at least a component of at least one of the in-phase path and the quadrature phase path operates and an order of filtering is selected based on a blocker power of the image channel.

In another example aspect, the receiver further includes a mixer coupled to receive the first and second output and coupled to receive a signal from a second local oscillator corresponding to the image channel.

In another example aspect, a method for operating a receiver includes receiving an output of an in-phase IF path; receiving an output of a quadrature IF path; measuring a blocker power on a plurality of IF channels on at least one of the in-phase path and the quadrature path within a fraction of a symbol interval; selecting a selected one of the plurality of IF channels having a low blocker power as an image channel; and providing a local oscillator output to the in-phase IF path and quadrature IF path operate corresponding to the image channel, such that a frequency of the local oscillator output is changed within a fraction of the symbol interval.

In another example aspect, the measuring measures each of the plurality of IF channels is measured during the symbol interval in a staggered manner.

In yet another example aspect, the plurality of IF channels is a number of IF channels such that a probability that of at least one of the plurality of IF channels has a low blocker energy is high.

In another example aspect, the method in which the in-phase path and the quadrature path further include: at least one of an IF amplifier, an IF filter, and an analog-to-digital converter, and the IF amplifiers, the IF filters, and the analog-to-digital converters are operated with a bandwidth substantially higher than an actual channel bandwidth.

In another example aspect, the image channel is a channel having a lowest blocker power.

In another example aspect, the method further includes mixing an output of at least one of the in-phase IF path and the quadrature IF path with a frequency corresponding to the image channel.

Modifications are possible in the described aspects of the present application, and other arrangements are possible that are within the scope of the claims.

1. An integrated circuit, comprising:
a first input coupled to receive an output of an in-phase IF path;
a second input coupled to receive an output of a quadrature IF path; and
a channel monitor coupled to the first and second inputs, the channel monitor configured to measure a blocker power on a plurality of IF channels within a fraction of a symbol interval and providing a local oscillator output coupled to a local oscillator that controls an IF channel used by the in-phase IF path and the quadrature IF path, the channel monitor configured to:
select a selected one of the plurality of IF channels having a low blocker power as an image channel and provide a signal on the local oscillator output, causing the local oscillator to provide a local oscillator frequency such that the in-phase IF path and quadrature IF path operate at the image channel, such that the local oscillator frequency is changed within a fraction of the symbol interval.

2. (canceled)

3. The integrated circuit of claim 1 in which each of the plurality of IF channels is measured during the symbol interval in a staggered manner.

4. The integrated circuit of claim 1 in which the in-phase path and the quadrature path further include: at least one of an IF amplifier, an IF filter, and an analog-to-digital converter, and each of the IF amplifiers, the IF filters, and the analog-to-digital converter is operated with a bandwidth substantially higher than an actual channel bandwidth.

5. The integrated circuit of claim 1 in which the channel monitor is configured to select the channel having a lowest blocker power for the image channel.

6. The integrated circuit of claim 1 in which the channel monitor determines an intermodulation (IMD) product of the plurality of IF channels to determine an effect of blockers on the IMD product to select an IF channel where the blockers have low effect on the IMD product that affects the desired channel.

7. The integrated circuit of claim 1 further including a mixer to mix an output of at least one of the in-phase IF path and the quadrature IF path with a frequency corresponding to the image channel.

8. The integrated circuit of claim 1 in which at least one of a gain and a biasing of at least a component of at least one of the in-phase path and the quadrature phase path operates and an order of filtering is selected based on a blocker power of the image channel.

9. The integrated circuit of claim 1 and further including a path enable signal to disable one of the in-phase IF path and the quadrature IF path when the blocker power of the image channel is below a threshold.

10. A receiver, comprising:
an in-phase IF path providing a first output;
a quadrature IF path providing a second output;
a local oscillator having an output coupled to the in-phase IF path and the quadrature IF path that controls an IF channel used by the in-phase IF path and the quadrature IF path, and having a frequency control input; and
a channel monitor coupled to receive the first and second output, the channel monitor configured to measure a blocker power on a plurality of IF channels within a fraction of a symbol interval and provide a local oscillator frequency output coupled to the frequency control input of the local oscillator, the channel monitor configured to select a selected one of the plurality of IF channels having a low blocker power as an image channel and providing a signal on the local oscillator frequency output causing the local oscillator to provide a local oscillator frequency such that the in-phase IF path and quadrature IF path operate at the image channel, such that the local oscillator frequency is changed within a fraction of the symbol interval.

11. The receiver of claim 10 in which in which the in-phase path and the quadrature path further include: at least one of an IF amplifier, an IF filter, and an analog-to-digital converter, and the IF amplifiers, the IF filters, and the analog-to-digital converter are operated with a bandwidth substantially higher than an actual channel bandwidth.

12. The receiver of claim 10 in which the in-phase IF path and the quadrature IF path are configured to enter a lower power mode when the blocker power of the image channel is below a threshold.

13. The receiver of claim 10 in which each of the plurality of IF channels is measured during the symbol interval in a staggered manner.

14. The receiver of claim 10 in which at least one of a gain and a biasing of at least a component of at least one of the in-phase path and the quadrature phase path operates and an order of filtering is selected based on a blocker power of the image channel.

15. The receiver of claim 10 further including a mixer coupled to receive the first and second output and coupled to receive a signal from a second local oscillator corresponding to the image channel.

16. A method for operating a receiver, comprising:
receiving an output of an in-phase IF path;
receiving an output of a quadrature IF path;
measuring a blocker power on a plurality of IF channels on at least one of the in-phase path and the quadrature path within a fraction of a symbol interval;
selecting a selected one of the plurality of IF channels having a low blocker power as an image channel; and
providing a local oscillator output to the in-phase IF path and quadrature IF path operate corresponding to the image channel, such that a frequency of the local oscillator output is changed within a fraction of the symbol interval.

17. The method of claim 16 in which the measuring measures each of the plurality of IF channels is measured during the symbol interval in a staggered manner.

18. The method of claim 16 in which the in-phase path and the quadrature path further include: at least one of an IF amplifier, an IF filter, and an analog-to-digital converter, and the IF amplifiers, the IF filters, and the analog-to-digital converters are operated with a bandwidth substantially higher than an actual channel bandwidth.

19. The method of claim 16 in which the image channel is a channel having a lowest blocker power.

20. The method of claim 16 further including mixing an output of at least one of the in-phase IF path and the quadrature IF path with a frequency corresponding to the image channel.
